(19) United States
(12) Patent Application Publication
(10) Pub. No.: US 2006/0065750 A1
(43) Pub. Date: Mar. 30, 2006

(54) Measurement, scheduling and reporting system for energy consuming equipment

(76) Inventor: Keith W. Fairless, Nevada City, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/134,057

(22) Filed: May 20, 2005

Related U.S. Application Data
(60) Provisional application No. 60/574,009, filed on May 21, 2004.

(51) Int. Cl. F23N 5/20; G05D 23/00

(52) U.S. Cl. 236/46 R

(57) ABSTRACT

Disclosed are embodiments of an HVAC control system that automatically and periodically monitors potentially large amounts of HVAC data in real time, controls the HVAC system in response to the monitored data, and compiles data and produces reports using the compiled data upon user request. The reports can include data regarding the costs associated with operating the HVAC system, schedules for operating the HVAC system, and setpoints at which certain equipment of the HVAC system should be operated at a future time.

### RELATED APPLICATION

This application claims the benefit of priority under 35 U.S.C. § 119(e) to U.S. Provisional Patent Application No. 60/574,009, filed May 21, 2004 and entitled “MEASUREMENT, SCHEDULING AND REPORTING SYSTEM FOR ENERGY CONSUMING EQUIPMENT” which is incorporated herein by reference in its entirety.

### BACKGROUND OF THE INVENTION

1. Field of the Invention

The invention generally relates to control of energy consuming equipment. More particularly, the invention relates to computerized systems and methods for measuring, scheduling, managing, controlling and reporting operations of heating, ventilating (or ventilation) and air conditioning (HVAC) systems.

2. Description of the Related Technology

HVAC refers to the equipment, distribution network, and terminals that provide either collectively or individually the heating, ventilating, or air-conditioning processes to a building. Generally speaking, HVAC systems provide heating, cooling, and ventilation, air handling, and air quality. More specifically, HVAC systems can include furnaces, boilers, heat pumps, air handlers, chillers, cooling towers, air conditioners and other environmental control systems for structures such as commercial buildings and residential homes.

A simple example of an HVAC system involves the heating and cooling of a home. Many homes are heated by a furnace, often powered by natural gas or electricity, and cooled by air conditioners, typically powered by electricity. In most homes, the power (on/off) and temperature settings of the furnace and air conditioner are controlled by a central thermostat. Some thermostats are manually controlled, while others are programmable to provide automated control through selection of various operating parameters. For example, programmable thermostats can allow for selecting various parameters such as desired temperature settings and times during the day to change the designated temperature setting. Once the temperature settings and times are entered, the programmable thermostats operate in an automated manner according to the entered parameters. In most home HVAC systems, the only temperature sensor (device for measuring the temperature of a building at the location of the sensor) is located within the thermostat.

HVAC systems in commercial buildings are typically more complex due to various factors that include the much larger space being environmentally controlled, the greater diversity in the size of various rooms (for example, a building with both a large production room and a number of small offices), the potential for large energy savings due to the considerable amount of energy consumption, and the many types of heating and cooling systems available. Commercial HVAC systems often include numerous temperature sensors, humidity sensors, status signals (for example, whether a particular fan is off or on), and control signals (for example, to control air flow by changing the position of a damper, a damper being a movable plate that regulates the flow of a gas or liquid in an HVAC system). Complex commercial HVAC systems often utilize a direct digital control (DDC) system that manages the operation of the HVAC system by allowing programming of the DDC and monitoring and controlling a multitude of input and output signals.

Present HVAC systems utilizing DDC require considerable operator input for data collection, and only perform many functions upon request of an operator or other user. For example, present systems do not collect in real time the large amounts of data necessary for generating the various reports that enable the user to monitor, assess and schedule the operation of the HVAC system. The present systems are therefore more expensive to operate due to the labor intensive tasks performed by the operator(s) and by the decreased efficiency of the operation of the HVAC system caused by data that is not automatically kept up to date and readily available. Therefore, what is needed is an HVAC control system that automatically and periodically monitors and compiles potentially large amounts of HVAC data in real time, controls and schedules the operation of the HVAC system in response to the monitored data, and produces reports using the compiled data either automatically or upon user request. The reports can include data regarding the costs associated with operating the HVAC system, schedules for operating the HVAC system, and setpoints at which certain equipment of the HVAC system should be operated at a future time. The HVAC control system is also configured to generate commands to operate the energy consuming equipment and to operate the energy consuming equipment in accordance with the generated commands.

### SUMMARY OF CERTAIN INVENTIVE ASPECTS

The systems and methods of the invention have a multitude of features, no single one of which is solely responsible for their desirable attributes. Without limiting the scope of the invention, as expressed by the claims that follow, the more prominent features will now be discussed briefly. After considering this discussion, and particularly after reading the section entitled “Detailed Description of Certain Embodiments,” one of ordinary skill in the technology will understand how the features of the system and methods provide various advantages over traditional systems.

One aspect is a measurement and reporting system for energy consuming equipment. The system comprises a control and monitoring system coupled to one or more pieces of energy consuming equipment, the control and monitoring system configured to control, at least in part, the operation of the energy consuming equipment, and configured to store information related to actual operation and defined operational parameters of the energy consuming equipment, one or more energy consumption meters configured to track delivery of energy from an energy supply utility to the energy consuming equipment, and an energy supply utility computer system receiving and storing information from the energy consumption meters and receiving and storing information regarding energy supply pricing. The system further comprising a computerized reporting system configured to receive stored information from the control and monitoring system and from the energy supply utility computer system, wherein the reporting system is configured to process, automatically or upon request by a user, at least some of the information from the energy supply utility computer system and the control and monitoring system so as to produce data indicative of costs associated with operating the energy consuming equipment, and wherein the reporting system is configured to output a report containing the data to a user of the measurement and reporting system.

Another aspect is a measurement and scheduling system for energy consuming equipment. The system comprises a control and monitoring system coupled to one or more pieces of energy consuming equipment, the control and monitoring system configured to control, at least in part, the operation of the energy consuming equipment, and configured to store information related to actual operation and defined operational parameters of the energy consuming equipment, one or more energy consumption meters configured to track delivery of energy from an energy supply utility to the energy consuming equipment, and an energy supply utility computer system receiving and storing information from the energy consumption meters and receiving and storing information regarding energy supply pricing. The system further comprises a computerized schedule optimizing system configured to receive stored information from the control and monitoring system and from the energy supply utility computer system, wherein the schedule optimizing system is configured to process, automatically or upon request by a user, at least some of the information from the energy supply utility computer system and the control and monitoring system so as to produce data indicative of costs associated with operating the energy consuming equipment under predicted future operating conditions, and wherein the schedule optimizing system is configured to output a report containing a schedule for operating at least some of the energy consuming equipment and setpoints at which at least some of the energy consuming equipment should be operated at a future time.

Yet another aspect is a measurement and reporting system for energy consuming equipment. The system comprises a control and monitoring system coupled to one or more pieces of energy consuming equipment, the control and monitoring system configured to control, at least in part, the operation of the energy consuming equipment, and configured to store information related to actual operation and defined operational parameters of the energy consuming equipment, one or more energy consumption meters configured to track delivery of energy from an energy supply utility to the energy consuming equipment, and an energy supply utility computer system receiving and storing information from the energy consumption meters and receiving and storing information regarding energy supply pricing. The system further comprises a computerized control system remote from the control and monitoring system, the remote computerized control system configured to receive stored information from the control and monitoring system and from the energy supply utility computer system, wherein the remote computerized control system is configured to process, automatically or upon request by a user, at least some of the information from the energy supply utility computer system and the control and monitoring system so as to produce data indicative of costs associated with operating the energy consuming equipment, and wherein the computerized control system is configured to output commands to the control and monitoring system, and wherein the control and monitoring system operates the energy consuming equipment in accordance with the commands.

Still another aspect is a method of measuring and reporting data associated with energy consuming equipment. The method comprises controlling, at least in part, the operation of energy consuming equipment, storing information related to actual operation and defined operational parameters of the energy consuming equipment, tracking delivery of energy from an energy supply utility to the energy consuming equipment, and receiving and storing information from the energy supply utility. The method further comprises receiving and storing information regarding energy supply pricing, processing, automatically or upon request by a user, at least some of the stored information related to actual operation and defined operational parameters of the energy consuming equipment so as to produce data indicative of costs associated with operating the energy consuming equipment, and generating a report including the data indicative of costs associated with operating the energy consuming equipment.

Another aspect is a method of measuring data and scheduling operations of energy consuming equipment. The method comprises controlling, at least in part, the operation of energy consuming equipment, storing information related to actual operation and defined operational parameters of the energy consuming equipment, tracking delivery of energy from an energy supply utility to the energy consuming equipment, and receiving and storing information from the energy consumption meters. The method further comprises receiving and storing information regarding energy supply pricing, processing, automatically or upon request by a user, at least some of the information related to actual operation and defined operational parameters of the energy consuming equipment so as to produce data indicative of costs associated with operating the energy consuming equipment under predicted future operating conditions, and generating a report containing a schedule for operating at least some of the energy consuming equipment and setpoints at which at least some of the energy consuming equipment should be operated at a future time.

Still another aspect is a method of measuring and reporting data associated with energy consuming equipment. The method comprises controlling, at least in part, the operation of energy consuming equipment, storing information related to actual operation and defined operational parameters of the energy consuming equipment, tracking delivery of energy from an energy supply utility to the energy consuming equipment, receiving and storing information from the energy consumption meters, and receiving and storing information regarding energy supply pricing. The method further comprises receiving the stored information related to actual operation and defined operational parameters of the energy consuming equipment, processing, automatically or upon request by a user, at least some of the information so as to produce data indicative of costs associated with operating the energy consuming equipment, generating commands to operate the energy consuming equipment, and operating the energy consuming equipment in accordance with the commands.

### BRIEF DESCRIPTION OF THE DRAWINGS

The above and other aspects, features and advantages of the invention will be better understood by referring to the following detailed description, which should be read in conjunction with the accompanying drawings. These drawings and the associated description are provided to illustrate certain embodiments of the invention, and not to limit the scope of the invention.

FIG. 1 is a block diagram illustrating embodiments of a top-level architecture of the energy management and control system.

FIG. 2 is a system diagram illustrating one example of a computer system for execution of the energy management and control system of FIG. 1.

FIG. 3 is a flowchart illustrating an embodiment of a measurement and reporting process as performed by the energy management and control system shown in FIG. 1.

FIG. 4 is a flowchart illustrating an additional embodiment of a measurement and reporting process as performed by the energy management and control system shown in FIG. 1.

FIG. 5 is a flowchart illustrating a further embodiment of a measurement and reporting process as performed by the energy management and control system shown in FIG. 1.

FIG. 6 is a block diagram illustrating an embodiment of the schedule optimizer module of the control and monitoring system shown in FIG. 1.

FIG. 7 is a block diagram illustrating an embodiment of the real-time setpoint controller module of the control and monitoring system shown in FIG. 1.

FIG. 8 is an example of a whole building approach (DOE Option C) report screen as generated by the computerized reporting system module shown in FIG. 1.

FIG. 9 is an example of an HVAC equipment performance report screen as generated by the computerized reporting system module shown in FIG. 1.

FIG. 10 is an example of an HVAC runtime report screen as generated by the computerized reporting system module shown in FIG. 1.

FIG. 11 is an example of an HVAC temperature setpoint report screen as generated by the computerized reporting system module shown in FIG. 1.

FIG. 12 is an example of an energy conservation measure (ECM) performance report screen as generated by the computerized reporting system module shown in FIG. 1.

FIG. 13 is an example of a pool cogeneration quarterly report screen as generated by the computerized reporting system module shown in FIG. 1.

FIG. 14 is an example of an adjusted savings report screen as generated by the computerized reporting system module shown in FIG. 1.

### DETAILED DESCRIPTION OF CERTAIN EMBODIMENTS

The following detailed description is directed to certain specific embodiments of the invention. However, the invention can be embodied in a multitude of different ways as defined and covered by the claims. The scope of the invention is to be determined with reference to the appended claims. In this description, reference is made to the drawings wherein like parts are designated with like numerals throughout.

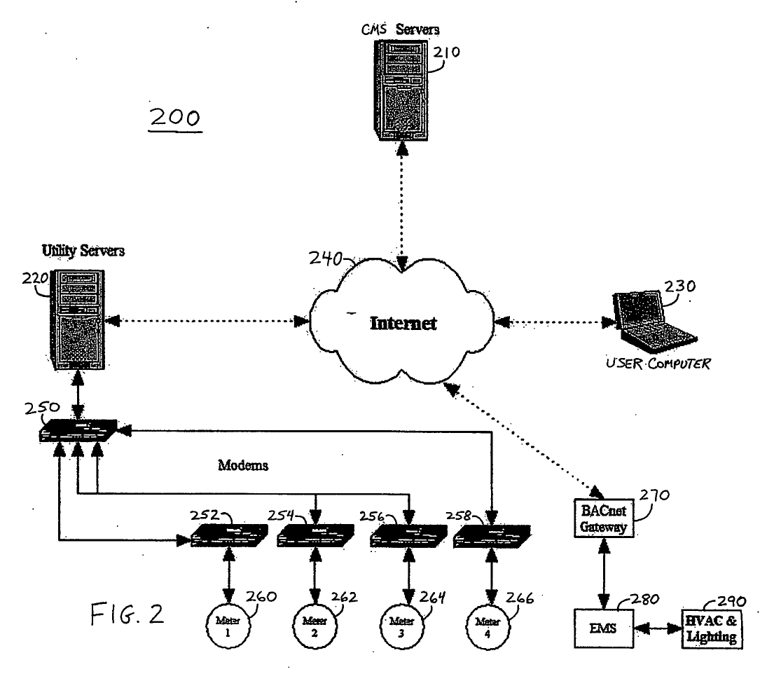

The functions performed by the energy management and control system include retrieving and storing equipment and utility meter data in real time, analyzing and manipulating the data, and reporting on the data in industry-specific ways. One example of the physical architecture of the system is illustrated in FIG. 2.

The electrical meters can be of the analog type, or of the digital type which can be converted to modem access. In some embodiments, the data is available in comma separated value (CSV) format at the energy utility provider website. The data is downloaded to the website operated by the energy management and control system. The data is additionally parsed and inserted into a database. The downloaded data can include kilowatt-hour (kWh) and kilowatt (kW) cost in certain time increments (for example, 15 minute increments) and the kWh, peak demand and peak demand cost for the billing period. A kilowatt is 1000 watts, a watt being a unit of power equal to the power dissipated by a current of one ampere flowing across a resistance of one ohm. The kilowatt-hour is a unit of energy equivalent to one kilowatt (1 kW) of power expended for one hour (1 h) of time. Data from the energy utility provider system can be received in a batch mode for each digital meter on a monthly basis.

In some embodiments of the energy management and control system (such as shown in FIG. 2), an energy management system (EMS) is accessed over the Internet via a hardware gateway that is able to communicate with the EMS via a BACnet protocol network. BACnet is an open, non-proprietary data communication protocol for building automation and control networks. Data from HVAC systems can be uploaded to the energy management and control system servers on a periodic basis, for example, every 15 minutes. Kilowatt (kW) and kilowatt-hour (kWh) consumption values can be modeled for systems without direct kW and kWh metering.

The energy management and control system includes a monitoring and verification (M&V) module. The M&V module can be accessed with a standard web browser, for example, Microsoft Internet Explorer or Netscape Navigator. The system is configured to acquire operational data and system performance information, for example, through existing building management systems or specific system sensors. This data can be transmitted, for example, via wireless network, wireless modem, Ethernet or direct phone connection, through a specific information gateway to the energy management and control system server. The data can be applied to a web-based reporting system and system equipment models to:
objectively measure real-time system efficiencies,
demonstrate base line operation standards,
document system operation compliance to industry standards such as ASHREA 90.1 or LEEDS Program, and
establish performance related metrics and track specific equipment performance.

The energy management and control system can graphically provide the specific intelligence to evaluate current operation and effectively plan system enhancements.

The M&V module includes a scheduling optimization module to incorporate real-time external fluctuations into the system performance evaluation to establish the most efficient mode of operation. The external influences can include:
building occupancy,
weather patterns,
energy rates, and
available equipment.

The M&V module can provide the on-site operation with a daily, equipment-specific operation plan to meet the plant output requirements in the most cost efficient manner.

Central plant operation can require the coordination of various discreet systems and equipment to produce the desired output. Interaction of these disparate components has a significant effect upon overall plant efficiencies. By building on the schedule optimization module, the energy management and control system has the capability to analyze operation, predict performance and provide the plant operator with specific setpoint modifications to ensure maximum plant performance. Output of the schedule optimization module includes verification and documentation of the performance parameters, for example, via a web-based reporting system.

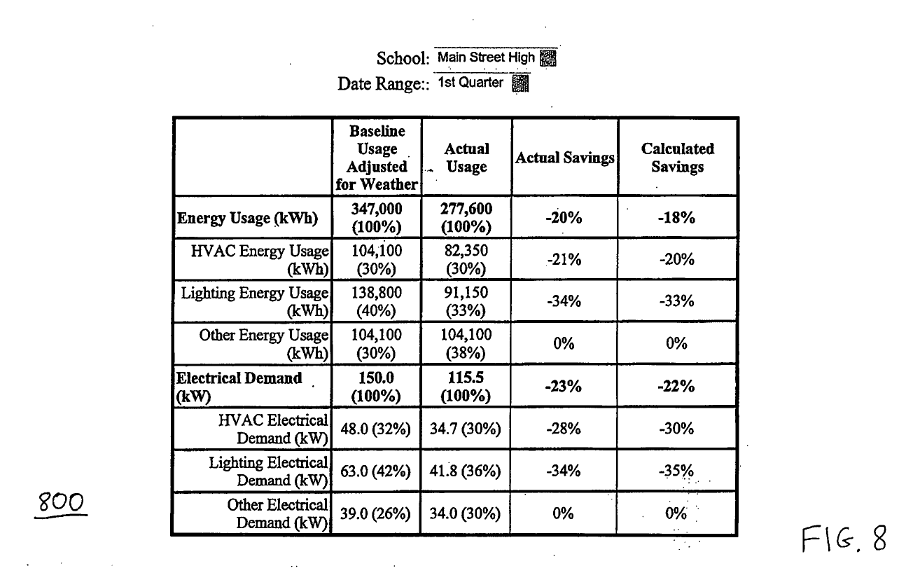

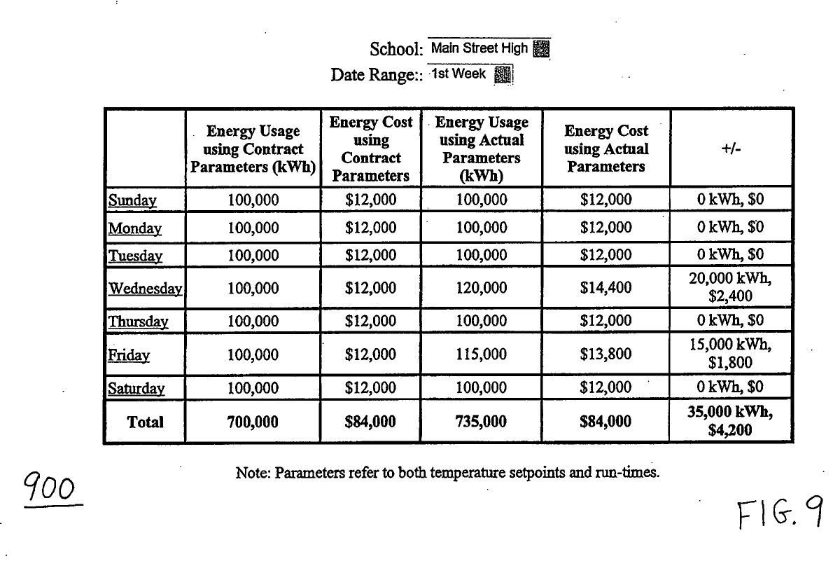

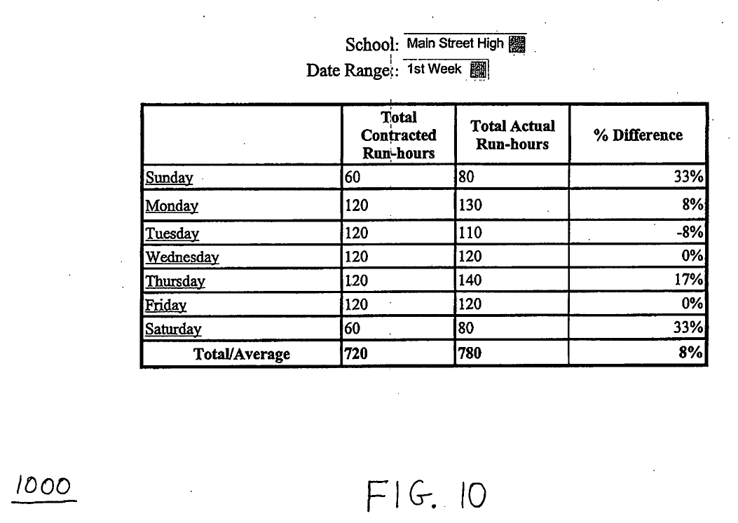

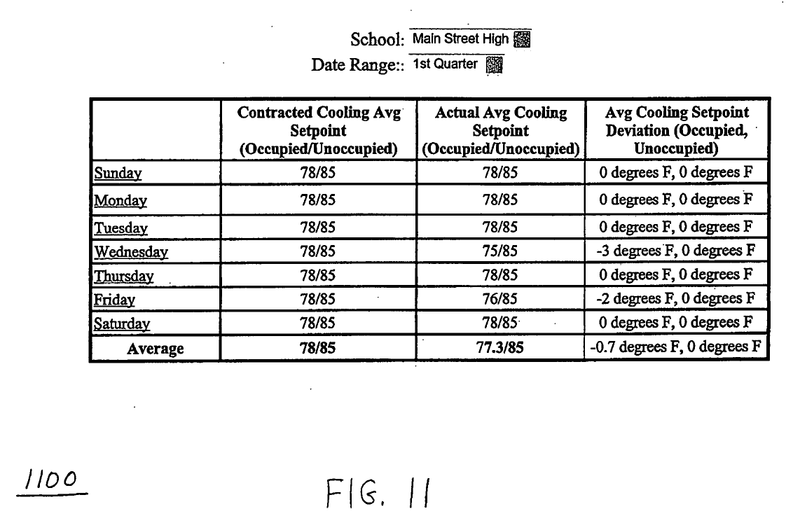

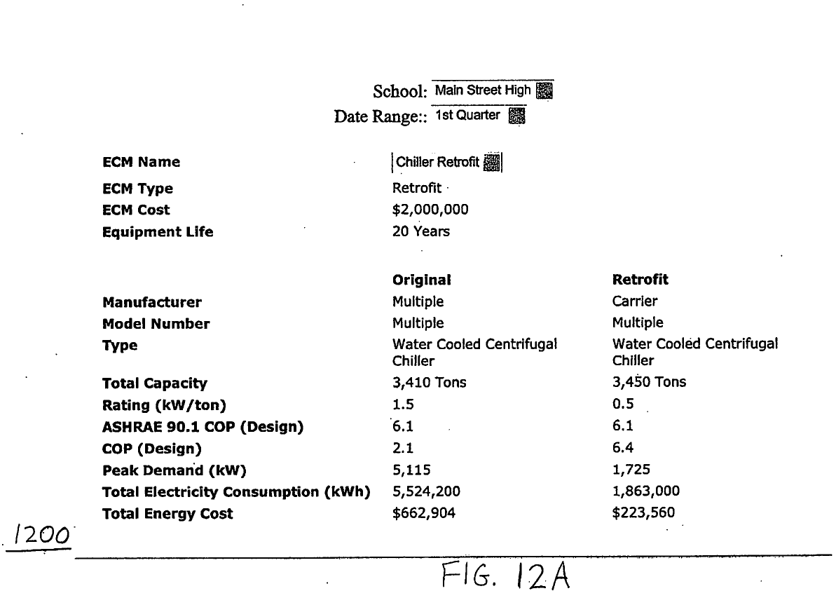

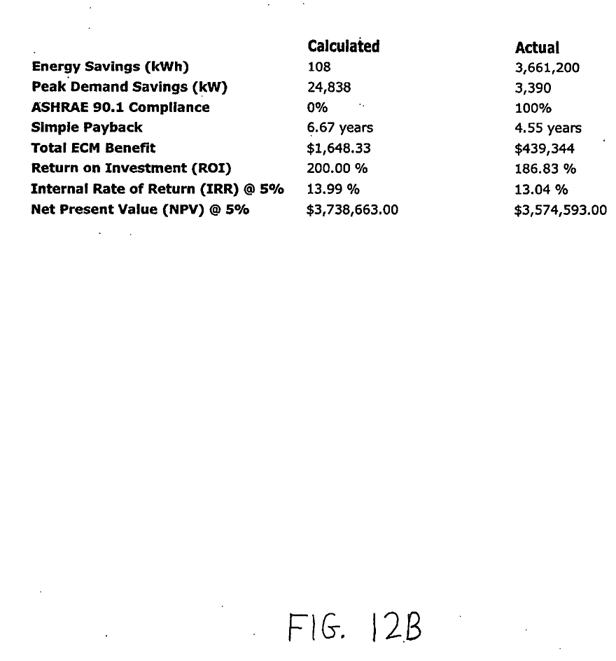

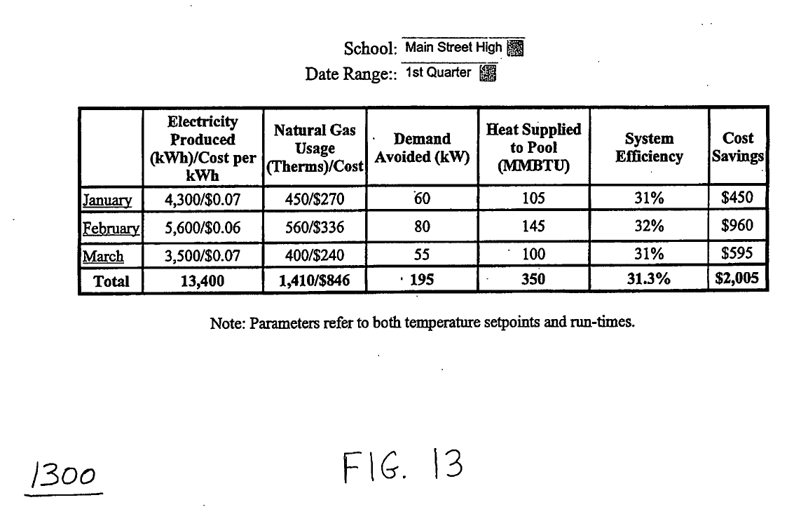

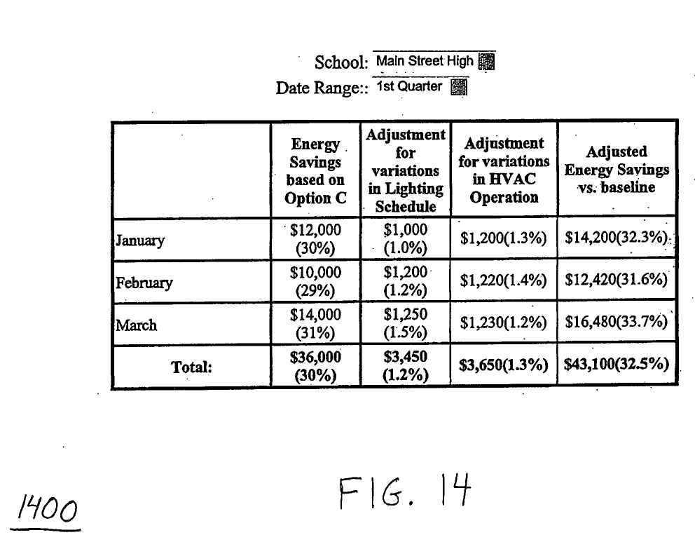

The users can request the energy management and control system to generate various reports that enable monitoring the performance of the various HVAC systems and components. The reports can include the DOE Option C Report (see FIG. 8), the HVAC Run-time Report (see FIG. 10), the HVAC Temperature Set Point Report (see FIG. 11), the HVAC Equipment Performance Report (see FIG. 9), the ECM Performance Report (see FIG. 12), the Pool Cogeneration Quarterly Report (see FIG. 13), and the Adjusted Savings Report (see FIG. 14). The rationale and the mechanics of each report are described below.

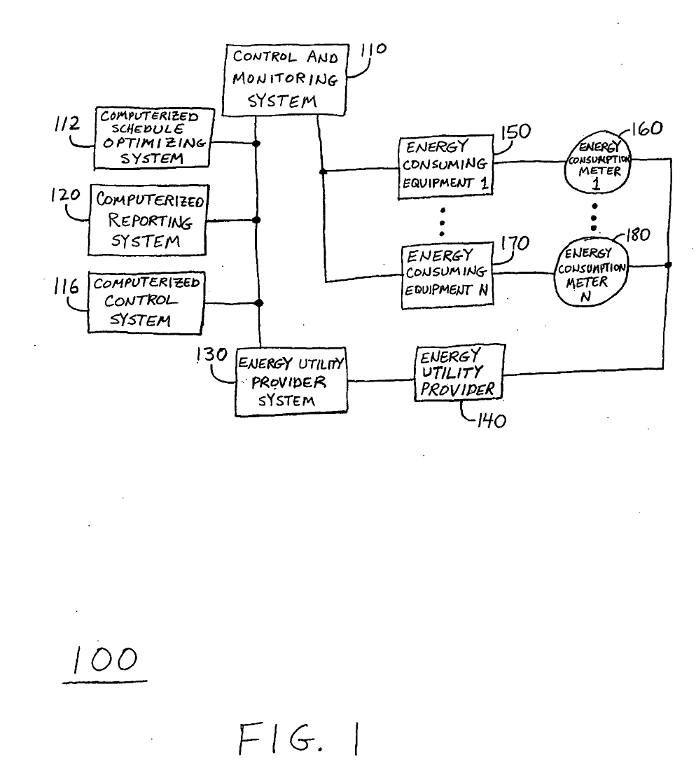

Referring now to the figures, FIG. 1 is a block diagram illustrating embodiments of a top-level architecture of the energy management and control system 100. The energy management and control system 100 in FIG. 1 includes a piece of energy consuming equipment 1 150. The energy consuming equipment 1 150 can include, for example, furnaces, boilers, heat pumps, air handlers, chillers, cooling towers, air conditioners and lights. The energy management and control system 100 can include one or more additional pieces of energy consuming equipment N 170, as indicated by the designation ‘N.’ Each piece of the energy consuming equipment 150, 170 can be connected to one or more energy consuming meters that measures and makes available the amount of energy consumed by the respective piece of energy consuming equipment. As shown in the embodiment of FIG. 1, an energy consumption meter 1 160 is connected to the energy consuming equipment 1 150, and an energy consumption meter N 180 is connected to the energy consuming equipment N 170. In some embodiments, some pieces of energy consuming equipment can be connected to more than one energy consumption meter, while in other embodiments some pieces of energy consuming equipment can have no energy consumption meter connected.

The energy management and control system 100 shown in FIG. 1 additionally includes an energy utility provider 140 that is connected to each of the energy consumption meters 1-N 160, 180. The energy utility provider 140 is the supplier of energy to the consumer. Several examples of energy utility providers are Southern California Edison (SCE), San Diego Gas & Electric (SDG&E), Consolidated Edison Company of New York (ConEdison, or ConEd), and Commonwealth Edison (ComEd). The energy management and control system 100 additionally includes an energy utility provider system 130, which is a computer system of the energy utility provider 140 for performing utility provider functions and communicating with other computer systems. The energy utility provider system 130 is connected to the energy utility provider 140 as shown in FIG. 1.

The energy management and control system 100 additionally includes a control and monitoring system 110 for controlling the operation of the energy consuming equipment 150 170 storing information related to the actual operation and defined operational parameters of the energy consuming equipment 150 170. The control and monitoring system 110 is connected to the energy consuming equipment 150 170 and the energy utility provider system 130. The control and monitoring system 110 is additionally connected to a computerized schedule optimizing system 112.

The computerized schedule optimizing system 112 receives stored information from the control and monitoring system 110 and from the energy utility provider system 130. In addition, the computerized schedule optimizing system 112 processes the information from the energy utility provider system 130 and the control and monitoring system 110 and produces data regarding costs associated with operating the energy consuming equipment 150 170 under predicted future operating conditions. The information processing by the computerized schedule optimizing system 112 can be performed automatically or upon a user request to perform the information processing.

The computerized schedule optimizing system 112 can additionally output one or more reports that include a schedule for operating the energy consuming equipment 150 170, and setpoints to use in operating the energy consuming equipment 150 170 in the future. In some embodiments, the computerized schedule optimizing system 112 can also receive data related to future predicted weather conditions, for example, cloudy or sunny conditions, temperature, and precipitation. Still further, the computerized schedule optimizing system 112 can model the costs of energy consuming equipment operation under different operating schedules and setpoints.

The energy management and control system 100 additionally includes a computerized reporting system 120 connected to the control and monitoring system 110. In some embodiments, the computerized reporting system 120 receives stored information from the control and monitoring system 110 and from the energy utility provider system 130. The computerized reporting system 120 processes the information from the energy utility provider system 130 and from the control and monitoring system 110 and produces data regarding costs associated with operating the energy consuming equipment 150 170. The information processing by the computerized reporting system 120 can be performed automatically or upon a user request to perform the information processing. The computerized reporting system 120 can additionally output one or more reports including the cost data to a user of the system.

In some embodiments, the computerized reporting system 120 can retrieve data automatically from one or both of the energy utility provider system 130 and control and monitoring system 110 at predetermined intervals. The computerized reporting system 120 can output the reports automatically at predetermined intervals. Alternatively, the reports can be output upon request by the user. The report can include a comparison of the actual performance of the energy consuming equipment 150 170 to the predicted performance of the same or different energy consuming equipment.

The energy management and control system 100 shown in FIG. 1 additionally includes a computerized control system 116 connected to the control and monitoring system 110. The computerized control system 116 receives stored information from the control and monitoring system 110 and from the energy utility provider system 130. The computerized control system 116 processes the received information and produces data regarding the costs associated with operating the energy consuming equipment 150 170. The computerized control system 116 can output the reports automatically at predetermined intervals. Alternatively, the reports can be output upon request by the user. The computerized control system 116 also outputs commands to the control and monitoring system 110, which operates the energy consuming equipment 150 170 according to the commands.

In some embodiments, the energy management and control system 100 can include only the control and monitoring system 110, the computerized schedule optimizing system 112, the computerized reporting system 120 and the computerized control system 116. In these embodiments, the energy consuming equipment 1 150, the energy consuming equipment N 170, the energy consumption meter 1 160, the energy consumption meter N 180, the energy utility provider 140, and the energy utility provider system 130 are separate from the energy management and control system 100. In other embodiments, the systems and components shown in FIG. 1 can be allocated or subdivided in numerous other ways.

While the embodiment in FIG. 1 shows a certain configuration of systems and connections, other embodiments utilize other system configurations. For example, the functionality of the various systems shown in FIG. 1 can be combined into fewer systems or split into additional systems in many different arrangements. Additionally, the connections between the systems shown in FIG. 1 can be, for example, hard-wired connections, private networks, public networks, local area networks, wide area networks, and wireless connections. One common public network is the Internet. In embodiments utilizing the Internet, users can use web browsers, for example, Microsoft Explorer and Netscape Navigator, to access the data and have the data displayed to the user.

FIG. 2 is a system diagram illustrating one example of a computer system 200 for execution of the energy management and control system 100 of FIG. 1. In this example, HVAC and lighting units 290 are monitored using an energy management system (EMS) 280, and the data is collected using a BACnet compatible gateway 270. The gateway 270 can be a software system, a hardware system, or a combination of software and hardware, that resides at one of the remote sites on an industrial grade personal computer (PC). The meter information can be collected from an energy utility provider server 220. The data can be collected at a periodic interval, for example, at a 15 minute interval. Users can access the data and run reports via the energy management and control system 100 by using a standard web browser.

The computer system 200 in the example of FIG. 2 is flexible and can be tailored to any number of energy savings projects. Examples of the reports that can be generated by the systems shown in FIGS. 1 and 2 are illustrated in FIGS. 8-14 and described below. The energy conservation measures applied can include the following: chiller retrofits, lighting retrofits, HVAC controls and cogeneration. Utilizing the installed HVAC controls, the performance contractor has based energy savings on both contracted setpoints and contracted equipment run times.

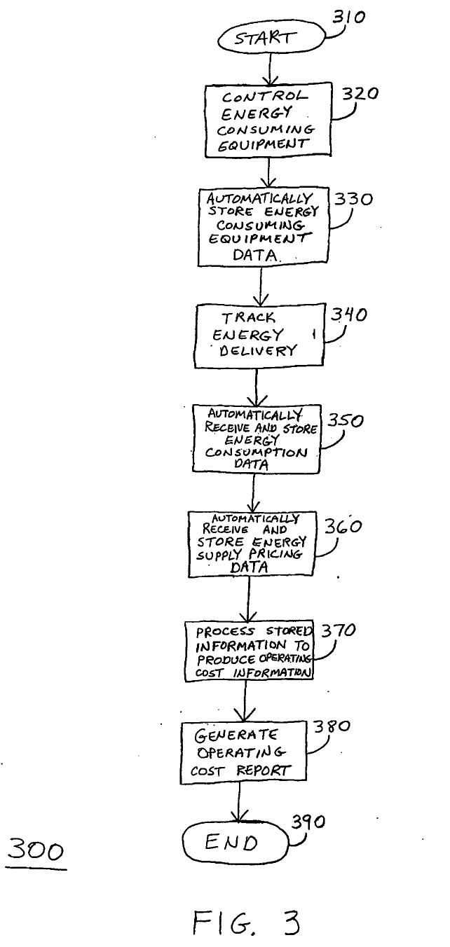

FIG. 3 is a flowchart illustrating an embodiment of a measurement and reporting process 300 as performed by the energy management and control system 100 shown in FIG. 1. The process begins at a start state 310. The process then moves to a state 320 where the energy management and control system 100 controls the energy consuming equipment. Next, at a state 330 the energy management and control system 100 automatically stores energy consuming equipment data. The process continues to a state 340 where the energy management and control system 100 tracks energy delivery. Moving to a state 350, the energy management and control system 100 automatically receives and stores energy consumption data. The process continues at a state 360 where the energy management and control system 100 automatically receives and stores energy supply pricing data. Next, at a state 370, the energy management and control system 100 processes stored information to produce operating costs information. The process continues to a state 380 where the energy management and control system 100 generates an operating cost report. The process then moves to an end state 390.

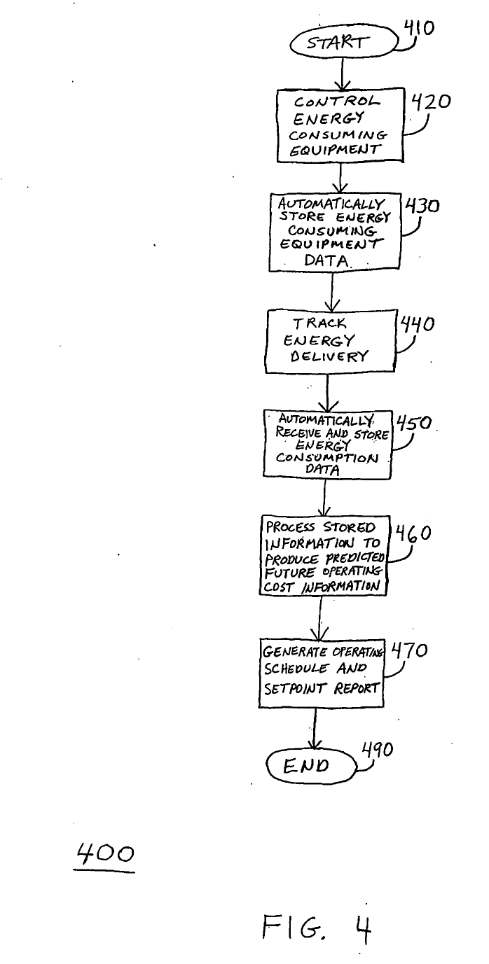

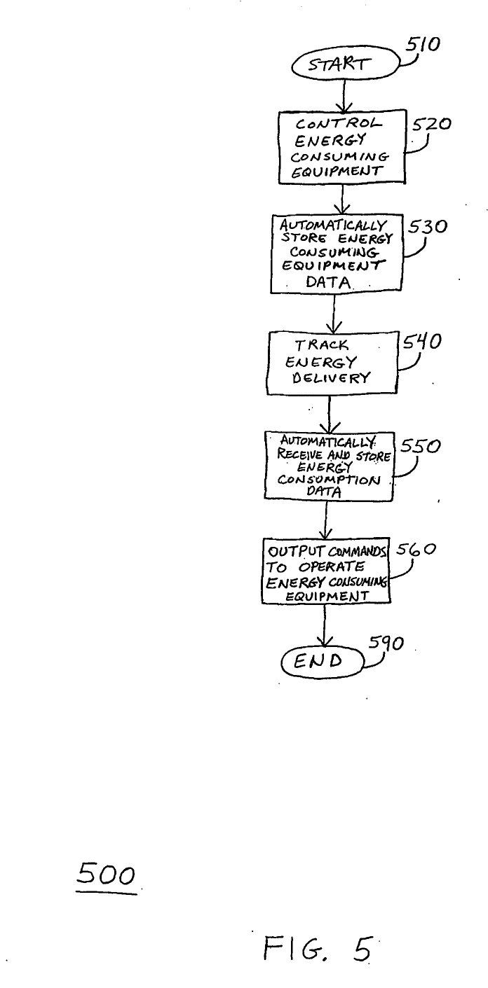

FIG. 4 is a flowchart illustrating an additional embodiment of a measurement and reporting process 400 as performed by the energy management and control system 100 shown in FIG. 1. The process begins at a start state 410. The process then moves to a state 420 where the energy management and control system 100 controls the energy consuming equipment. Next, at a state 430 the energy management and control system 100 automatically stores energy consuming equipment data. The process continues to a state 440 where the energy management and control system 100 tracks energy delivery. Moving to a state 450, the energy management and control system 100 automatically receives and stores energy consumption data. The process continues at a state 460 where the energy management and control system 100 processes the stored information to produce predicted future operating cost information. Next, at a state 470, the energy management and control system 100 generates an operating schedule and setpoint report. The process then moves to an end state 490.

FIG. 5 is a flowchart illustrating a further embodiment of a measurement and reporting process 500 as performed by the energy management and control system 100 shown in FIG. 1. The process begins at a start state 510. The process then moves to a state 520 where the energy management and control system 100 controls the energy consuming equipment. Next, at a state 530 the energy management and control system 100 automatically stores energy consuming equipment data. The process continues to a state 540 where the energy management and control system 100 tracks energy delivery. Moving to a state 550, the energy management and control system 100 automatically receives and stores energy consumption data. The process continues at a state 560 where the energy management and control system 100 outputs commands to operate the energy consuming equipment. The process then moves to an end state 590.

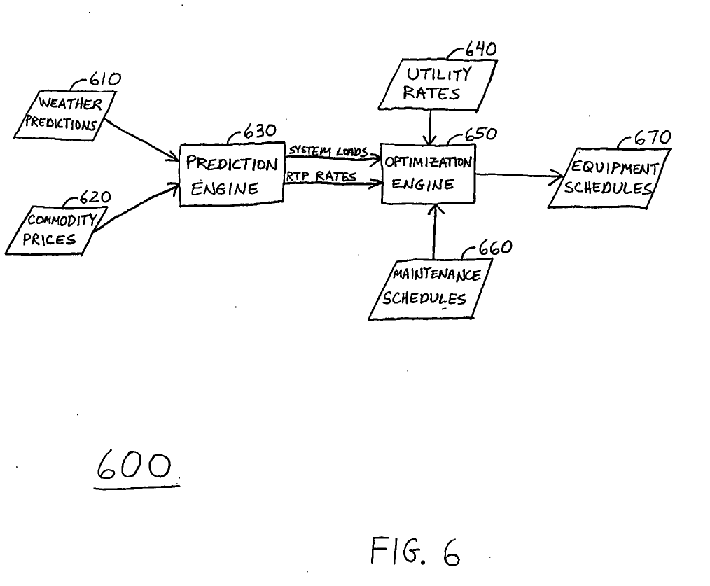

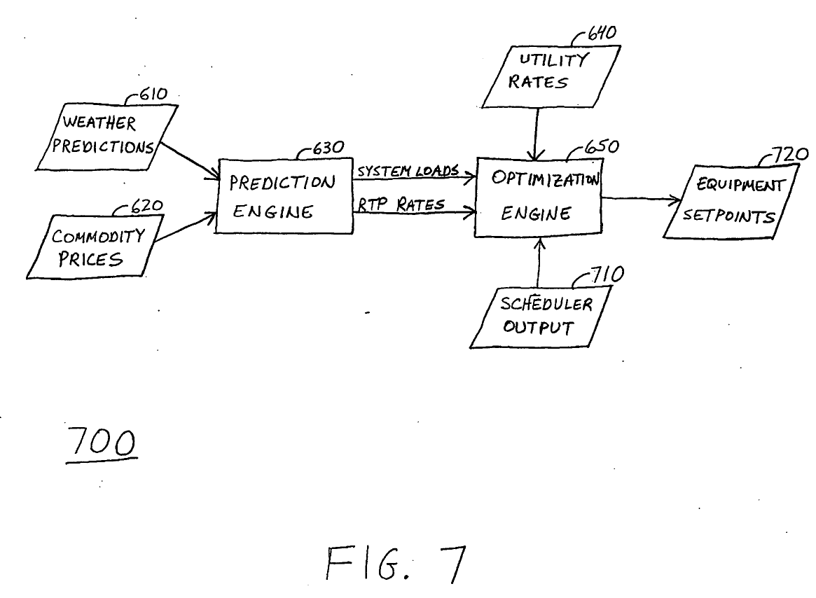

FIG. 6 is a block diagram illustrating an embodiment of a schedule optimizer process 600 of the control and monitoring system module 110 shown in FIG. 1. In certain embodiments the schedule optimizing system 112 relies at least in part on one or more models from the M&V module to develop equipment schedules 670 for the equipment and systems. These modules may include, for example, a weather predictions module 610, a commodity prices module 620, a predictive engine 630, a utility module 640, an optimizing engine 650, and maintenance schedules 660.

The weather predictions module 610 is configured to determine short and/or long-term weather forecasts. The weather predictions are utilized to forecast energy loads. In certain embodiments, forecasts are obtained from an Internet-based weather prediction service. The commodity prices module 620 forecasts short and/or long-term real-time pricing rates.

In certain embodiments, the prediction engine 630 receives data from the weather predictions module 610 and the commodity prices module 620 and determines predicted system loads and real-time pricing rates for the optimization engine 650.

The optimization engine 650 determines the equipment schedules 670 based on the system loads and real-time pricing rates determined by the prediction engine 630. In certain embodiments, the optimization engine receives 650 utility rates from the utility rates module 640 and maintenance schedules from the maintenance schedule module 660. The maintenance schedules may be in the form of detailed system and equipment models.

The schedule optimizer process 600 can produce equipment schedules 670 that utilize equipment while reducing energy costs for a building/facility without adversely affecting occupant comfort. In certain embodiments the schedule optimizer process 600 takes into account whether the building/facility has multiple fuel options, the ability to shed demand, and/or on-site power generation. The schedule optimizer process 600 can obtain short and long-term commodity price predictions, for example gas, coal, and the like, from a forecasting service if real-time pricing real-time pricing is in effect for the customer facility. The schedule optimizer process 600 can predict the system loads, for example cooling loads, heating loads, demand, and the like, as well as real-time pricing rates.

FIG. 7 is a block diagram illustrating an embodiment of a real-time setpoint controller process 700 of the control and monitoring system module 110 shown in FIG. 1. The real-time setpoint controller module processing includes optimizing equipment setpoints, for example, based on the output of the scheduler optimizer module (see FIG. 6), and providing equipment operational setpoints. These setpoints (e.g., chilled water supply setpoint, cooling tower supply setpoint, etc.) can be calculated using the mathematical models utilized in the scheduler optimizer module and the real-time setpoint controller module in a global optimization scheme. Instead of trying to operate equipment on an individual basis, the equipment setpoints can be calculated to minimize energy cost across the entire system, building or facility.

FIG. 8 is an example of a whole building approach (DOE Option C) report 800 screen as generated by the computerized reporting system module 120 shown in FIG. 1. This report replicates the “Whole Building” Option C M&V method as presented by the Department of Energy (DOE). For example, in embodiments in which the energy management and control system is installed at multiple schools in a particular school district, the user can choose a date range and a school, or the district as a whole, and compare the actual performance of the project versus what was projected in the pre-installation phase (for example, the post-project energy costs versus the baseline energy costs).

Actual utility data can be used, as well as applicable data acquired from the existing EMS. Modeled or actual HVAC consumption, lighting consumption, and other energy consumption can be displayed. When applicable, the modeled HVAC systems takes into account the electrical demand of each usage component at the time of the coincident demand (for example, the hour at which the energy utility provider determines the maximum electrical demand has occurred).

Baseline energy consumption can be input from an original energy conservation program report and can include three categories of energy usage: HVAC system, lighting, and miscellaneous energy consumption. For the baseline consumption, the operating characteristics (for example, supply temperature set point, space temperature, the chilled water supply and return temperature, weather conditions, etc.) can be applied to a generated model of the HVAC systems and chillers before they were replaced or new controls added.

Lighting system usage can be stipulated based upon pre-installation lighting surveys. Alternatively, lighting data is used from the EMS if it is available. However, if it is not available, the usage can be extrapolated from the calculations that were used for the stipulated savings after lighting system retrofit.

In some embodiments, miscellaneous usage is calculated by subtracting modeled HVAC and stipulated lighting consumption from the weather adjusted total energy consumption. Post installation HVAC consumption can be calculated by directly accessing operational data through the EMS. If kWh or kW usage is available, that can be used for the actual consumption. If kWh or kW usage is not available, first principle models and regression analysis can alternatively be used to estimate the usage.

For the post-installation energy analysis, miscellaneous loads can be estimated by subtracting the estimated HVAC and lighting usage from the total usage. The post-installation miscellaneous usage can be used with an agreed upon escalation factor applied. The whole building approach report screen is available in a printable format.

The following table provides a description of each column in the whole building approach report example shown in FIG. 8.

| Baseline Usage Adjusted | The amount of usage or demand, adjusted for |
|---|---|
| for Weather | weather, in the baseline year. |
| Actual Usage | The amount of usage or demand. |
| Actual Savings | The actual savings based on option C. |
| Calculated Savings | The savings that were calculated for the time |
| | period. |

FIG. 9 is an example of an HVAC equipment performance report 900 screen as generated by the computerized reporting system module 120 shown in FIG. 1. The HVAC equipment performance report compares the molded performance of the HVAC equipment with the specified performance at contracted set points. Data collected from the HVAC systems and equipment modeling can be used to identify the usage and costs of both actual and baseline operational modes. Energy usage charges and the electrical demand of the equipment at the coincident peak can be used to calculate the costs for both cases, if applicable. The HVAC equipment performance report screen is available in a printable format.

FIG. 10 is an example of an HVAC runtime report 1000 screen as generated by the computerized reporting system module 120 shown in FIG. 1. The HVAC runtime report compares the run-times of the HVAC equipment to their contracted run-times. In the school district example, the date range is user-definable and a school or the whole district can be chosen. By clicking on a day, the details for that day are displayed. The HVAC run-time report can be displayed on a unit, school, or district basis. In some embodiments, the data for this report can be extracted from the EMS. The HVAC runtime report is available in a printable format.

FIG. 11 is an example of an HVAC temperature setpoint report 1100 screen as generated by the computerized reporting system module 120 shown in FIG. 1. A backup report to the HVAC Equipment Performance Report, the HVAC temperature setpoint report enables the user the ability to assess the HVAC performance, based on setpoints, for a whole week or for whatever date range is desired. For example, if a certain day is selected, an hourly report is generated. In the school district example, the HVAC setpoint can be displayed on a unit, school, or district basis. In some embodiments, the data for this report can be extracted from the EMS. The HVAC temperature setpoint report is available in a printable format.

The HVAC temperature setpoint report provides the user the capability to compare the contracted temperature setpoints to the actual temperature setpoints for a specified date range. For example, if a day is selected, an hourly report is generated. The HVAC setpoints can be displayed on a unit, school, or district basis.

FIGS. 12A and 12B together make up an example of an energy conservation measure (ECM) performance report 1200 screen as generated by the computerized reporting system module 120 shown in FIG. 1. The ECM performance report includes an evaluation of the performance of an energy conservation measure (ECM) over a user selected data range. This report can additionally include performance metrics that are useful to both energy managers and financial professionals. The ECM performance report provides, for example, a performance contractor the ability to track the performance of identified ECMs.

The ECM performance report evaluates the performance of an energy conservation measure (ECM) over a user selected date range. This report provides performance metrics that can be useful to both energy managers and financial professionals. The ECM performance report additionally enables a performance contractor the ability to track the performance of identified ECMs. The basic idea is to present ECM performance independent of how the equipment is operated, thus providing an “apples to apples” comparison of the retrofit performance.

The following table provides a description of the columns in the ECM performance report 1200 example shown in FIG. 12.

| | |
|---|---|
| ECM Name | A unique name to identify the energy conservation |
| | measure (ECM). Typical names would be “Chiller |
| | Retrofit” or “Pump Upgrade”. |
| ECM Number | A unique positive number used to identify the ECM. |
| ECM Type | The type of ECM. Typical types would be “Retrofit” |
| | or “New Construction”. |
| ECM Cost | The total cost of the ECM installation. Costs included |
| | are for design, equipment, installation, commissioning, |
| | maintenance, etc. |
| Calculated ECM | The yearly savings attributed to the ECM on a yearly |
| Yearly Savings | basis. This number would be the basis, along with the |
| | ECM cost, upon whether an ECM was implemented or |
| | not. |
| Equipment Life | The expected life of the equipment installed. This |
| | parameter is used for the financial calculations. |
| Report Date | The time frame to be reported on with respect to the |
| Range | ECM installation. |
| Manufacturer | The equipment/system manufacturer. |
| Model Number | The model number by which the equipment/system is |
| | identified |
| Type | The type of equipment/system. |
| Capacity | The total capacity (for example, tons, kW, BTU, etc.) |
| | of the equipment/system installed. |
| Rating | The efficiency rating of equipment/system at design |
| | conditions. This is the number published by the |
| | manufacturer. |
| ASHRAE 90.1 | The minimum coefficient of performance (COP) desig- |
| COP (Design) | nated in the ASHRAE 90.1 performance specification |
| | for the equipment being analyzed. |
| COP (Design) | The actual COP of the original and replacement equip- |
| | ment at design conditions. |
| Peak Demand | The energy input at peak operating conditions. |
| Total Energy | The total energy consumption for the date range |
| Consumption | selected. For the installed equipment this number |
| | is the 1 collected value or the value calculated given |
| | the operating conditions. The baseline number is calcu- |
| | lated by applying data collected to the model of the |
| | retrofitted equipment. |
| Total Energy | The cost of the energy consumed for the date range |
| Cost | selected. The total energy cost of the installed |
| | equipment is calculated using the applicable utility |
| | rate tariff. The baseline usage is calculated |
| | hourly with the same tariff. |
| Energy Savings | The energy savings that were calculated and the energy |
| | that has been saved for the user selected date range. |
| Demand Savings | The total reduction in monthly peak demand that was |
| | calculated before ECM installation and the 1 savings |
| | that have occurred. |
| ASHRAE 90.1 | The percentage of the hours that the equipment |
| Compliance | complied with the ASHRAE 90.1 standard. For certain |
| | equipment types like chillers the compliance COP |
| | changes given the operating conditions. |
| Simple Payback | The simple payback, in years, of the equipment for the |
| | date range selected. The ECM cost is scaled for the |
| | date range selected and reflects the ECM performance |
| | for that date range. The simple payback reflects how |
| | long in years it will take for the savings to equal |
| | the overall investment. This is generally not an |
| | accurate decision tool but it is frequently used |
| | based on its simplicity to calculate and understand. |
| ECM Benefit | The ECM benefit for the date range selected. This is |
| | in units of dollars. |
| Return on | The ROI for the life of the ECM equipment/system. |
| Investment | The benefit is projected out based on the date range |
| (ROI) | selected. The ROI reflects the total benefit minus the |
| | total costs divided by the total costs and multiplied |
| | by 100. |
| Internal Rate | The internal rate of return for the investment is the dis- |
| of Return | count rate that makes the present value of the ECM |
| (IRR) @ 5% | income stream total to zero. |
| Net Present | The net present value method (NPV) of evaluating an |
| Value | ECM project allows you to consider the time value of |
| (NPV) @ 5% | money. Essentially, it helps you find the present value |
| | in “today's dollars” of the future net cash flow of a |
| | project. Then, you can compare that amount with the |
| | amount of money needed to implement the project. If |
| | the NPV is greater than the cost, the project will |
| | be profitable. |

FIG. 13 is an example of a pool cogeneration quarterly report 1300 screen as generated by the computerized reporting system module 120 shown in FIG. 1. The pool cogeneration quarterly report includes the energy cost savings and the cogeneration efficiency based on the cost and consumption of natural gas, and based on the amount of electricity produced and of heat generated and used for heating the pools.

Continuing with the school district example, an HVAC system can include two micro turbines such as Capstone C60's. These micro turbines produce a peak electrical output of 60 kW. They are connected to heat exchangers to provide hot water to the pools at two high schools in the school district. The energy utility provider has provided digital electric meters to measure the electricity produced, and gas meters and BTU meters can be installed to measure the gas input and waste heat produced. While the natural gas and waste heat consumption can be measured directly, the electrical energy output can be gathered from the energy utility provider's website. The pool cogeneration quarterly report is available in a printable format.

The following table provides a description of the columns in the pool cogeneration quarterly report example shown in FIG. 13.

| | |
|---|---|
| Electricity Produced | The amount of electricity produced by the cogen- |
| (kWh)/Cost per kWh | eration units and the cost to produce it. |
| Natural Gas Usage | The amount of natural gas consumed and its cost. |
| (Therms)/Cost | |
| Demand Avoided | The demand avoided at the peak hour by the |
| (kW) | operation of the cogeneration units. |
| Heat Supplied | The amount of heat generated for useful work. |
| (MMBTU) | |
| System Efficiency | The overall efficiency of the units. |
| Cost Savings | The total cost savings associated with the installa- |
| | tion of the cogeneration units. |

FIG. 14 is an example of an adjusted savings report 1400 screen as generated by the computerized reporting system module 120 shown in FIG. 1. The adjusted savings report includes the data and information of the whole building approach (DOE Option C) report 800 (see FIG. 8), the HVAC temperature setpoint report 1100 (see FIG. 11), and the HVAC runtime report 1000 (see FIG. 10). The adjusted savings report 1400 includes adjustments to the Option C energy savings calculation by including the effects of operating HVAC units and lighting systems outside of the contracted parameters (for example, setpoints and schedules.) The date range can be selectable and individual schools or the whole district can be reported on in the school district example.

The following table provides a description of each column in the adjusted savings report example shown in FIG. 14.

| | |
|---|---|
| Energy Savings | For the date range, this indicates the monthly energy |
| based on | savings accounted for in option C. The actual monthly |
| Option C | usage can be adjusted for weather factors. Usage and |
| | percentage of total saved can also be displayed. |
| Adjustment for | This value represents the costs accrued when the actual |
| variations in | lighting schedule differs from the contracted lighting |
| Lighting Schedule | schedule. |
| Adjustment for | The HVAC units operate using contracted temperature |
| variations in | setpoints and contracted schedules. This value repre- |
| HVAC Operation | sents the costs associated with operating the equipment |
| | differently than is specified in the contract. |
| Adjusted Energy | This value represents the final savings taking into |
| Savings vs. | account overall usage and the costs of operation out- |
| baseline | side of what was specified in the contract. |

While the above detailed description has shown, described, and pointed out novel features of the invention as applied to various embodiments, it will be understood that various omissions, substitutions, and changes in the form and details of the device or process illustrated may be made by those of ordinary skill in the technology without departing from the spirit of the invention. This invention may be embodied in other specific forms without departing from the essential characteristics as described herein. The embodiments described above are to be considered in all respects as illustrative only and not restrictive in any manner. The scope of the invention is indicated by the following claims rather than by the foregoing description.

What is claimed is:

1. A measurement and reporting system for energy consuming equipment comprising:
a control and monitoring system coupled to one or more pieces of energy consuming equipment, said control and monitoring system configured to control, at least in part, the operation of said energy consuming equipment, and configured to store information related to actual operation and defined operational parameters of said energy consuming equipment;
one or more energy consumption meters configured to track delivery of energy from an energy supply utility to said energy consuming equipment;
an energy supply utility computer system receiving and storing information from said energy consumption meters and receiving and storing information regarding energy supply pricing;
a computerized reporting system configured to receive stored information from said control and monitoring system and from said energy supply utility computer system, wherein said reporting system is configured to process, automatically or upon request by a user, at least some of said information from said energy supply utility computer system and said control and monitoring system so as to produce data indicative of costs associated with operating said energy consuming equipment, and wherein said reporting system is configured to output a report containing said data to a user of said measurement and reporting system.

2. The measurement and reporting system of claim 1, wherein said computerized reporting system is configured to retrieve data automatically from said energy supply utility computer at predetermined intervals.

3. The measurement and reporting system of claim 1, wherein said computerized reporting system is configured to retrieve data automatically from said control and monitoring system at predetermined intervals.

4. The measurement and reporting system of claim 1, wherein said computerized reporting system is configured to output said report automatically at predetermined intervals.

5. The measurement and reporting system of claim 1, wherein said computerized reporting system is configured to output said report upon request by a user.

6. The measurement and reporting system of claim 1, wherein said computerized reporting system is remote from said control and monitoring system.

7. The measurement and reporting system of claim 6, wherein said computerized reporting system is remote from said energy supply utility computer system.

8. The measurement and reporting system of claim 6, wherein said computerized reporting system communicates with said control and monitoring system and energy supply utility computer communicate over a public or private wide area network.

9. The measurement and reporting system of claim 8, wherein data in said computerized reporting system is accessed by a computer proximate to said control and monitoring system.

10. The measurement and reporting system of claim 9, wherein data in said computerized reporting system is accessed by a web browser program running on said computer.

11. The measurement and reporting system of claim 8, wherein data in said computerized reporting system is accessed by a computer remote from said control and monitoring system, said energy supply utility computer system and said computerized reporting system.

12. The measurement and reporting system of claim 11, wherein data in said computerized reporting system is accessed by a web browser program running on said computer.

13. The measurement and reporting system of claim 1, wherein said computerized reporting system is configured to output a report comparing actual performance of said energy consuming equipment to a predicted performance of the same or different energy consuming equipment.

14. A measurement and scheduling system for energy consuming equipment comprising:
a control and monitoring system coupled to one or more pieces of energy consuming equipment, said control and monitoring system configured to control, at least in part, the operation of said energy consuming equipment, and configured to store information related to actual operation and defined operational parameters of said energy consuming equipment;
one or more energy consumption meters configured to track delivery of energy from an energy supply utility to said energy consuming equipment;
an energy supply utility computer system receiving and storing information from said energy consumption meters and receiving and storing information regarding energy supply pricing;
a computerized schedule optimizing system configured to receive stored information from said control and monitoring system and from said energy supply utility computer system, wherein said schedule optimizing system is configured to process, automatically or upon request by a user, at least some of said information from said energy supply utility computer system and said control and monitoring system so as to produce data indicative of costs associated with operating said energy consuming equipment under predicted future operating conditions, and wherein said schedule optimizing system is configured to output a report containing a schedule for operating at least some of said energy consuming equipment and setpoints at which at least some of said energy consuming equipment should be operated at a future time.

15. The measurement and scheduling system of claim 14, wherein said computerized schedule optimizing system is configured to receive data related to future predicted weather conditions.

16. The measurement and scheduling system of claim 14, wherein said computerized schedule optimizing system is configured to model costs of energy consuming equipment operation under different operating schedules and setpoints.

17. A measurement and reporting system for energy consuming equipment comprising:
a control and monitoring system coupled to one or more pieces of energy consuming equipment, said control and monitoring system configured to control, at least in part, the operation of said energy consuming equipment, and configured to store information related to actual operation and defined operational parameters of said energy consuming equipment;
one or more energy consumption meters configured to track delivery of energy from an energy supply utility to said energy consuming equipment;
an energy supply utility computer system receiving and storing information from said energy consumption meters and receiving and storing information regarding energy supply pricing;
a computerized control system remote from said control and monitoring system, said remote computerized control system configured to receive stored information from said control and monitoring system and from said energy supply utility computer system, wherein said remote computerized control system is configured to process, automatically or upon request by a user, at least some of said information from said energy supply utility computer system and said control and monitoring system so as to produce data indicative of costs associated with operating said energy consuming equipment, and wherein said computerized control system is configured to output commands to said control and monitoring system, and wherein said control and monitoring system operates said energy consuming equipment in accordance with said commands.

18. A method of measuring and reporting data associated with energy consuming equipment comprising:
controlling, at least in part, the operation of energy consuming equipment;
storing information related to actual operation and defined operational parameters of said energy consuming equipment;
tracking delivery of energy from an energy supply utility to said energy consuming equipment;
receiving and storing information from said energy supply utility;
receiving and storing information regarding energy supply pricing;
processing, automatically or upon request by a user, at least some of said stored information related to actual operation and defined operational parameters of said energy consuming equipment so as to produce data indicative of costs associated with operating said energy consuming equipment; and
generating a report including said data indicative of costs associated with operating said energy consuming equipment.

19. A method of measuring data and scheduling operations of energy consuming equipment comprising:
controlling, at least in part, the operation of energy consuming equipment;
storing information related to actual operation and defined operational parameters of said energy consuming equipment;
tracking delivery of energy from an energy supply utility to said energy consuming equipment;
receiving and storing information from said energy consumption meters;
receiving and storing information regarding energy supply pricing;
processing, automatically or upon request by a user, at least some of said information related to actual operation and defined operational parameters of said energy consuming equipment so as to produce data indicative of costs associated with operating said energy consuming equipment under predicted future operating conditions; and
generating a report containing a schedule for operating at least some of said energy consuming equipment and setpoints at which at least some of said energy consuming equipment should be operated at a future time.

20. A method of measuring and reporting data associated with energy consuming equipment comprising:
controlling, at least in part, the operation of energy consuming equipment;
storing information related to actual operation and defined operational parameters of said energy consuming equipment;
tracking delivery of energy from an energy supply utility to said energy consuming equipment;
receiving and storing information from said energy consumption meters;
receiving and storing information regarding energy supply pricing;
receiving said stored information related to actual operation and defined operational parameters of said energy consuming equipment;
processing, automatically or upon request by a user, at least some of said information so as to produce data indicative of costs associated with operating said energy consuming equipment;
generating commands to operate said energy consuming equipment; and
operating said energy consuming equipment in accordance with said commands.
